(19) United States
(12) Patent Application Publication
(10) Pub. No.: US 2016/0326388 A1
(43) Pub. Date: Nov. 10, 2016

(54) COATED NANO-PARTICLE CATALYTICALLY ACTIVE COMPOSITE INKS

(71) Applicants: Robert PETCAVICH, The Woodlands, TX (US); Danliang JIN, The Woodlands, TX (US); EASTMAN KODAK COMPANY, Rochester, NY (US)

(72) Inventors: Robert J. Petcavich, The Woodlands, TX (US); Jin Danliang, The Woodlands, TX (US)

(21) Appl. No.: 15/108,803

(22) PCT Filed: Jan. 13, 2014
(86) PCT No.: PCT/US14/11299

§ 371 Date: Jun. 29, 2016

(51) Int. Cl. C09D 11/101; G06F 3/041; C09D 11/322; B41F 5/24; C09D 11/52; C09D 11/037

(52) U.S. Cl. CPC C09D 11/101; C09D 11/52; C09D 11/037; C09D 11/322; B41F 5/24; G06F 3/041; G06F 2203/04103

(57) ABSTRACT

Touch sensor circuits are used in touch screens for displays and graphical interfaces and may be, for example, resistive or capacitive touch sensor circuits. The touch sensor circuits may be manufactured using at least one catalytically active printable ink that may contain a plurality of radiation-curable binders, a plurality of coated electrically conductive nano-particles, a solvent, and may contain photo-initiators. The plurality of nanoparticles are coated by one of surfactants, polymers, or carbon. The ink is formulated to be used in a printing process such as a flexographic printing process or inkjet process to print complicated geometrics for microscopic patterns, particularly high resolution conductive patterns.

### CROSS-REFERENCE TO RELATED APPLICATION

None.

### BACKGROUND

Touch screen technology, for example, as is used in LCD or other display screens, comprises both resistive and capacitive touch sensor configurations. These sensors may be manufactured by assembling patterns of conductive material to form a conductive grid.

### SUMMARY

In an embodiment, a catalytically active printable ink comprising: a plurality of radiation-curable binders; a solvent; and a plurality of coated electrically conductive nanoparticles, wherein the plurality of nanoparticles are coated by at least one of surfactants, polymers, or carbon; wherein the ink has a viscosity between about 500 and about 10,000 cps at 25° C.

In an alternate embodiment, a method of manufacturing a touch screen sensor comprising: printing, using a first master plate and an ink, a first pattern on a first side of a substrate, wherein the first pattern comprises a first plurality of lines and a first tail, and wherein the ink comprises a plurality of binders, a solvent, and a plurality of carbon coated electrically conductive nanoparticles; curing the substrate; printing using a second master plate and the ink, a second pattern on one of a second substrate, the first side of the first substrate, or a second side of the first substrate, wherein the second pattern comprises a second plurality of lines and a second tail; curing the substrate; and plating the first pattern and the second pattern.

In an embodiment, a method of manufacturing a touch screen sensor comprising: preparing an ink, wherein the prepared ink comprises a plurality of binders, a solvent, and a plurality of carbon coated electrically conductive nanoparticles; printing, using a first master plate and the ink, a first pattern on a first side of a substrate, wherein the first pattern comprises a first plurality of lines and a first tail; curing the substrate; and plating the first pattern. The embodiment further comprising: printing using a second master plate and the ink, a second pattern on one of a second substrate, the first side of the first substrate, or a second side of the first substrate, wherein the second pattern comprises a plurality of lines, wherein the second pattern comprises a second plurality of lines and a second tail; curing the substrate; plating the second pattern; and assembling the first and the second patterns to form a touch sensor.

### BRIEF DESCRIPTION OF THE DRAWINGS

For a detailed description of exemplary embodiments of the invention, reference will now be made to the accompanying drawings in which:

FIG. 1 is a perspective view of an embodiment of an anilox roll 100.

FIG. 2 is a flowchart of an embodiment for touch sensor manufacture using a nano-composite ink.

FIGS. 3A-3C are illustrations of isometric and cross-sectional views of patterned flexo-masters.

FIGS. 4A and 4B are illustrations of top views of patterned flexoplates.

FIGS. 5A and 5B are illustrations of isometric view and a cross-sectional view of an embodiment of a capacitive touch sensor.

FIGS. 6A and 6B are illustrations of isometric view and a cross-sectional view of an embodiment of a resistive touch sensor.

FIG. 7 is an embodiment of a method of manufacturing touch sensors.

FIGS. 8A-8B are illustrations of embodiments of metered ink printing systems.

FIG. 9 is an illustration of the assembly of a capacitive touch sensor.

FIG. 10 is an illustration of a top view of a touch sensor assembly.

FIG. 11 is a top view and an exploded view of an assembled resistive touch screen sensor.

FIG. 12 is an exploded isometric view of a display having a capacitive touch screen structure.

FIG. 13 is an exploded isometric view of a display having a resistive touch screen structure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Touch screen technology may comprise different touch sensor configurations including capacitive and resistive touch sensors. Resistive touch sensors comprise several layers which face each other with a gap in between that may be preserved by spacers formed during the manufacturing process. A resistive touch screen panel may be comprised of several layers including two thin, metallic, electrically conductive layers separated by a gap that may be created by spacers. When an object such as a stylus, palm, or finger presses down on a point on the panel's outer surface, the two metallic layers come in contact and a connection is formed that causes a change in the electrical current. This touch event is sent to a controller for further processing.

Capacitive touch sensors may be used in electronic devices with touch-sensitive features. These electronic devices may include display devices such a computing device, a computer display, or a portable media player. Display devices may include televisions, monitors and projectors that may be adapted to displays images, including text, graphics, video images, still images or presentations. The image devices that may be used for these display devices may include cathode ray tubes (CRTs), projectors, flat panel liquid crystal displays (LCDs), LED systems, OLED systems, plasma systems, electroluminescent displays (ELDs), and field emissive displays (FEDs). As the popularity of touch screen devices increases, manufacturers may seek to employee methods of manufacture that will preserve quality while reducing the cost of manufacture and simplify the manufacturing process. The optical performance of touch screens may be improved by reducing optical interference, for example the moire effect that is generated by regular conductive patterns formed by photolithographic processes. Systems and methods of fabricating flexible and optically compliant touch sensors in a high-volume roll-to-roll manufacturing process where micro electrically conductive features can be created in a single pass are disclosed herein.

Two types of projected capacitance technology (PCT) which may be utilized in display screens are which can utilize either mutual capacitance or self-capacitance. A self-capacitance touch sensor may comprise a plurality of electrode lines along an X-axis and a Y-axis. In this example, each of the plurality of lines are pulsed and two fingers on any axis line of the plurality of lines produces the same result as having only one finger on that line. In this embodiment, first finger or stylus position and second finger or stylus position are read as one finger position. The other position may be referred to as a “ghost.”

In contrast, to a self-capacitance sensor, mutual capacitance sensors are comprised of an x-y grid where there is a capacitor at every intersection of each row and column of a first and a second assembled substrates or, in another example, a first substrate that has a pattern printed on a x-axis and a pattern printed on a y-axis and then cut and assembled to orient the patterns orthogonally. In a mutual capacitance sensor each of the plurality of lines along the X-axis are pulsed with voltage in turn and the plurality of lines along the Y-axis are scanned for changes in capacitance. Each node, wherein a node may comprise an x-y intersection, is individually address and an image of which nodes are touch is built up by measuring the voltage to determine the touch location. It should be noted that nodes are located at every intersection of the plurality of lines. In an embodiment, this allows multi-touch operation wherein multiple fingers, stylus, palms, or other conductive implements can be accurately tracked which allows for multi-point control and manipulation of the touch screen.

In summary, a capacitive touch sensor uses the electrons in a finger to detect contact, so a stylus or other implement would not work, whereas resistive panels only require pressure by an object, which could be a finger, palm, or inanimate object.

Disclosed herein are embodiments of a flexographic printing system comprising an ink used to print high resolution patterns that may be conductive. The ink, which may be used for applications on rigid substrates, for example, inkjet printing, as well outside of flexographic printing, comprises coated nano-particles and radiation-curable binders system, and a method to fabricate a resistive and a capacitive flexible touch sensor (FTS) circuit by, for example, a roll-to-roll manufacturing process using such an ink. It is appreciated that the term inkjet is used to describe a printing method by which electrically charged droplets of ink are sprayed on to a substrate.

The coated nano-particles may also be referred to as nano-composites and exhibit thixotropic flow behavior which may be desirable to print fine features as small as 1 micron in width. Thixotropic behavior is exhibited when a fluid such as an ink that is formed with the nano-composites is viscous under normal conditions but may become less viscous over time when agitated through shaking, shearing, or other manual or automated agitation processes. Thixotrophy may be a desirable property in inks used to form fine features and intricate geometries because the ink regains viscosity once it is applied, for example, to a substrate in a flexographic printing process, so that the integrity of the structure of the pattern printed is maintained. A plurality of master plates may be fabricated using thermal imaging of selected designs in order print high resolution conductive lines on a substrate. A first pattern may be printed using a first roll on a first side of the substrate, and a second pattern may be printed using a second roll on a second side of the substrate. Electroless plating may be used during the plating process. While electroless plating may be more time consuming than other methods, it may be better for small, complicated, or intricate geometries. The FTS may comprise a plurality of thin flexible electrodes in communication with a dielectric layer. An extended tail comprising electrical leads may be attached to the electrodes and there may be an electrical connector in electrical communication with the leads. The roll-to-roll process refers to the fact that the flexible substrate is loaded on to a first roll, which may also be referred to as an unwinding roll, to feed it into the system where the fabrication process occurs, and then unloaded on to a second roll, which may also be referred to as a winding roll, when the process is complete. In some embodiments where roll-to-roll handling is not employed, the ink(s) disclosed herein may be printed on rigid or comparatively rigid substrates such as glass, metal, ceramic, organic substances, as well as combinations thereof.

Touch sensors may be manufactured using a thin flexible substrate transferred via a known roll-to-roll handling method. The substrate is transferred into a washing system that may comprise a process such as plasma cleaning, elastomeric cleaning, ultrasonic cleaning process, etc. The washing cycle may be followed by thin film deposition in physical or chemical vapor deposition vacuum chamber. In this thin film deposition step, which may be referred to as a printing step, a transparent conductive material, such as Indium Tin Oxide (ITO), is deposited on at least one surface of the substrate. In some embodiments, suitable materials for the conductive lines may include copper (Cu), silver (Ag), gold (Au), nickel (Ni), tin (Sn) and Palladium (Pd) among others. Depending on the resistivity of the materials used for the circuit, it may have different response times and power requirements. The deposited layer of conductive material may have a resistance in a range of 0.005 micro-ohms to 500 ohms per cm, a physical thickness of 500 angstroms or less, and a width of 25 microns or more. In some embodiments, the printed substrate may have anti-glare coating or diffuser surface coating applied by spray deposition or wet chemical deposition. The coating on the substrate may be cured by, for example, visible light, ultraviolet light, or e-beam. This process may be repeated and several steps of lamination, etching, printing and assembly may be needed to complete the touch sensor circuit.

The pattern printed may be a high resolution conductive pattern comprising a plurality of lines. In some embodiments, these lines may be microscopic in size. The difficulty of printing a pattern may increase as the line size decreases and the complexity of the pattern geometry increases. The ink used to print features of varying sizes and geometries may also vary, some ink compositions may be more appropriate to larger, simple features and some more appropriate for smaller, more intricate geometries.

In an embodiment, there may be multiple printing stations used to form a pattern. These stations may be limited by the amount of ink that can be transferred on an anilox roll. In some embodiments, there may be dedicated stations to print certain features that may run across multiple product lines or applications, these dedicates stations may, in some cases, use the same ink for every printing job or may be standard features common to several products or product lines which can then be run in series without having to change out the roll. The cell volume of an anilox roll or rolls used in the transfer process, which may vary from 0.3-30 BCM (billion cubic microns) in some embodiments and 9-20 BCM in others, may depend on the type of ink being transferred. The type of ink used to print all or part of a pattern may depend on several factors, including the cross-sectional shape of the lines, line thickness, line width, line length, line connectivity, and overall pattern geometry. In addition to the printing process, at least one curing process may be performed on a printed substrate in order to achieve the desired feature height.

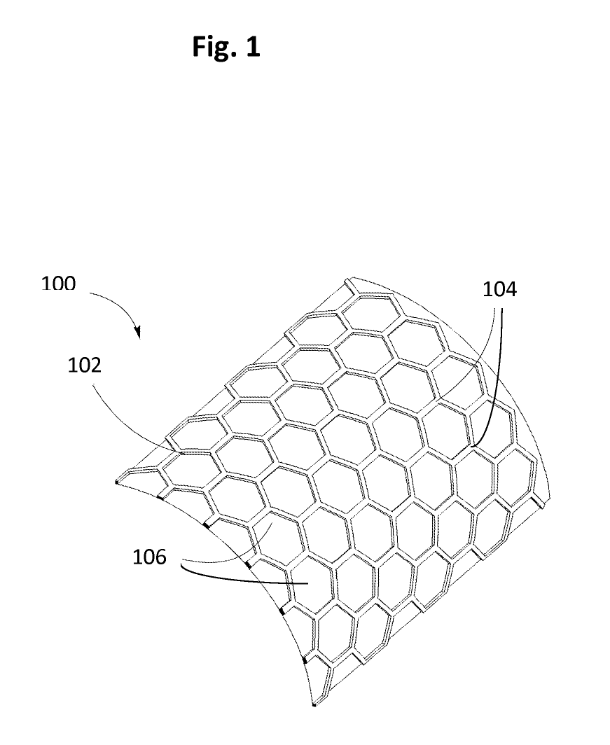

FIG. 1 is a perspective view of an embodiment of an anilox roll 100. In FIG. 1, the pattern shown has honeycomb cells structure 102. Honeycomb structure 102 comprises walls 104 spaced to create wells 106. In one example, the wells 106 of a particular pattern design may carry, within its cells, ink (not pictured) up to a thickness of about 14 microns on the flexo-plate, which may eventually end up with a coating thickness of 4-7 microns. The ink, described in detail below, comprises a plurality of radiation-curable binders, coated nano-particles that act as catalytic seeds, and, in some embodiments, a photo-initiator.

During the flexographic printing process, honeycomb cells structure 102 may function to pick up ink in the wells 106 and retain the ink in the wells 106 that is going to be transferred to the substrate. The ink from the walls 104 of the honeycomb features of the anilox roll 100 is not imprinted on the substrate in the honeycomb pattern. Instead, ink is transferred from the anilox roll 100 to a flexo-plate, then flows on to the substrate, forming a homogeneous coating on the substrate, that is, the honeycomb structure acts to transfer the ink to the patterned flexo-plate. In other embodiments (not pictured) structures other than the honeycomb structure may be used instead of or in addition to the honeycomb geometry wherein other surface geometries are those such as diamond, circles, zig-zags, or other geometries as appropriate to transfer the ink homogenously. However, a flat, unpatterned anilox roll may not be able to carry as much ink as the anilox roll with the honeycomb cells structure, so in embodiments where a thicker coating is preferred for the desired anti-glare properties.

Ink Preparation

The ink used in s flexographic process may be water-based, solvent-based, and/or UV-curable. The type of ink utilized in a flexographic process may depend, for example, on the type of substrate to be printed, the complexity of the print pattern, the geometry of the pattern, or a combination of multiple factors. Preferably, the ink is prepared in a way that it can be transferred accurately from either an ink pan or an ink metering system to a flexo-plate, and then to a target substrate, with consistent volume from the flexoplate. The ink should be prepared so that it has good adhesion to the substrate, and can cure instantaneously at a high printing speed, for example, 750 feet per minute (fpm). The substrate may be comprised of polyethylene terephthalate (PET), polymethyl methacrylate (PMMA), polycarbonate, celluloses, cycloaliphatic polymers, paper, or other suitable material. Preferably, the printed structure will have good adhesion to the substrate and be robust for daily handling such as scratch resistance. The printed structure may be a plurality of lines, wherein the term lines is used to describe geometric features created by a line or lines of the plurality of lines.

The ink disclosed herein is a UV-curable ink that may comprise a solvent component and also may comprise a plurality of radiation-curable binders and coated nano-particles and, in some embodiments, a photoinitiator. Radiation curable compositions possess compatibility of the coated nano-particles without particle aggregation after being fully dispersed. Coated nano-particles, which may maintain homogeneous distribution without settling during storage and handling. The coating on the nano-particles may comprise dispersion promotion layers such as surfactants, polymers, and carbon. The coated nano-particles are protected from possible oxidation due to the high surface energy of the coated nano-particles. The dispersion enhancing layer on the coated nano-particles enhances the compatibility and distribution of the coated nano-particles within the radiation curable resins, thereby no aggregation phenomenon takes place in the short and long term storage and use of the dispersion. Meanwhile, the coating on the nanoparticles does not block the ions' access to the particle surface as a catalyst/catalytic effect, this access is desirable and contributes to the plating process. Electroless catalysts such as palladium compounds may not be needed. Conventionally, catalytic particles may not be compatible with polymeric binders, however, the coated nano-particles disclosed herein are compatible and may be homogenized in a mixture with polymers as disclosed below. These coated nano-particles, or nano-composites, are radiation curable compositions were designed for high speed printing and that, when used in a printing process such as a flexo-graphic printing process to maintain a high level of precision of printed features. The properties of the cured binder from radiation process do not block the access of the ions to nanoparticles from the following plating process, which is essential. Using an ink composition as disclosed herein enables printing of lines as small as 1 micron in width. The printed material such as a substrate can be printed using an ink that comprises a solvent but in a quantity that may result in an overall manufacturing process that may not utilize an additional solvent removal step (i.e. an additional thermal baking step). Thixotropic properties may be achieved and maintain with solvent in the ink composition as discussed above. Since the coated nano-particles act as seeds for the plating process, there is no other catalyst in the ink that may require post-treatment activation prior to the electroless plating process. In addition, the ink patterns printed using an ink comprising a plurality of binders and a plurality of coated nano-particles can be plated at room temperature.

The nano-composites may comprise radiation curable binders including monomers, oligomers, and polymers. The plurality of binders may include 1,3-butylene glycol di(meth)acrylate, 1,4-butanediol di(meth)acrylate, 1,6 hexanediol di(meth)acrylate, alkoxylated aliphatic diacrylate, alkoxylated neopentyl glycol di(meth)acrylate, cyclohexane dimethanol di(meth)acrylate, diethylene glycol di(meth)acrylate, dipropylene glycol di(meth)acrylate, ethoxylated bisphenol a di(meth)acrylate, ethylene glycol di(meth)acrylate, neopentyl glycol dimethacrylate, polyester diacrylate, polyethylene glycol di(meth)acrylate, polypropylene glycol di(meth)acrylate, propoxylated neopentyl glycol diacrylate, tricyclodecane dimethanol diacrylate, triethylene glycol di(meth)acrylate, tripropylene glycol di(meth)acrylate, di-trimethylolpropane tetraacrylate, dipentaerythritol pentaacrylate, ethoxylated pentaerythritol tetraacrylate, dipentaerythritol pentaacrylate, which may also be low viscosity dipentaerythritol pentaacrylate, pentaacrylate ester, pentaerythritol tetraacrylate, ethoxylated trimethylolpropane triacrylate, ethoxylated trimethylolpropane triacrylate, ethoxylated trimethylolpropane triacrylate, highly propoxylated glyceryl triacrylate, trimethylolpropane triacrylate, which may also be low viscosity trimethylolpropane triacrylate, pentaerythritol triacrylate, propoxylated glyceryl triacrylate, propoxylated trimethylolpropane triacrylate, trimethylolpropane tri methacrylate, tris (2-hydroxy ethyl) isocyanurate tri(emth)acrylate, 2(2-ethoxyethoxy) ethyl acrylate, 2-phenoxyethyl methacrylate, 3,3,5 trimethylcyclohexyl methacrylate, alkoxylated lauryl acrylate, alkoxylated phenol acrylate, alkoxylated tetrahydrofurfuryl acrylate, caprolactone acrylate, cyclic trimethylolpropane formal acrylate, cycloaliphatic acrylate monomer, dicyclopentadienyl methacrylate, diethylene glycol methyl ether methacrylate, ethoxylated (4) nonyl phenol methacrylate, ethoxylated nonyl phenol acrylate, isobornyl methacrylate, isodecyl methacrylate, isooctyl acrylate, lauryl methacrylate, methoxy polyethylene glycol monomethacrylate, octyldecyl acrylate, stearyl methacrylate, tetrahydrofurfuryl methacrylate, tridecyl methacrylate, triethylene glycol ethyl ether methacrylate, poly(vinyl cinnamate), epoxy (meth)acrylate, epoxy (meth)acrylate oligomer, modified epoxy (meth)acrylate oligomer, aliphatic urethane (multi)(meth)acrylate, aromatic urethane (multi)(meth)acrylate, amine modified multifunctional polyester acrylate, hyperbranched polyester (meth)acrylate, carboxylated polyester (meth)acrylate, and N-methyl-4(4′-formylstyryl)pyridinium methosulfate acetal) poly(vinyl alcohol) etc.

The type of photoinitiator used may depend on the cross-linking mechanism of the plurality of binders used. Photo-initiators may be used in some embodiments of the common materials systems because of the broad availability of starting materials. A photoinitiator is a compound especially added to a formulation to convert absorbed light energy, UV or visible light, into chemical energy in the form of initiating species, viz., free radicals or cations. Based on the mechanism by which initiating radicals are formed. For photoinitiation to proceed efficiently the absorption bands of the photoinitiator must overlap with the emission spectrum of the source and there must be minimal competing absorption by the components of the formulation at the wavelengths corresponding to photoinitiator excitation, or a combination of photointiators, co-photoinitiators, and sensitizers. As discussed below, if e-beam curing is used as the curing mechanism, a photo-initiator may not be used. The photo-initiators and sensitizers may be, for example, acetophenone, anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(ii) hexafluorophosphate, dibenzosuberenone, 9,10-diethoxy and 9,10-dibutoxyanthracene, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2-ethylanthraquinone, 2-ethyl-9,10-dimethoxyanthracene, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, Isopropylthioxanthone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, thioxanthen-9-one, triarylsulfonium hexafluoroantimonate salts, mixed, 50% in propylene carbonate, and triarylsulfonium hexafluorophosphate salts, mixed, 50% in propylene carbonate. As discussed above, in certain circumstances, photoinitiators may not be used. For example, photo-initiators may not be used when e-beam is used as the high energy initiation source for curing, or when a photocycloaddition mechanism is used as crosslinking group such as N-methyl-4(4′-formylstyryl)pyridinium methosulfate acetal) poly(vinyl alcohol).

The ink may comprise conductive nano-particles including nano-metals, nano-oxides, and nano-carbon-based materials such as nano-tubes, nano-graphene, and bucky-balls. These conductive particles may be used as an alternative to plating catalysts that may be found in other types of ink used for flexo-graphic printing. Since there are no plating catalysts used, there is no catalyst activation process, and the plating process described below may be performed at room temperature as opposed to the elevated temperature that may be needed for a catalytic reaction to occur when plating catalysts are used. The ink may be used when a repeatable method of printing a wide range of feature sizes simultaneously is needed and may reduce the undercutting that may occur in photolithographic processes which may be a concern when the printed features that comprise the printed pattern are each less than 20 microns in width. In some embodiments, the printing process can be carried out at speeds up to 1000 ft/min. In addition, there may be improved adhesion/reduced delamination. Conductive nano-particles can be coated or isolated by surfactants, polymers, or carbon. The carbon on coated metal particles can be amorphous, sp2 hybridized, or graphene-like. The particle size can be 0.01-50 microns. The metals used may be copper (Cu), nickel (Ni), cobalt (Co), silver (Ag), gold (Au), iron (Fe), zinc (Zn), palladium (Pd), etc. The carbon coating may prevent aggregation of metal particles and readily dispersed in radiation curable matrix. The methods used to disperse the conductive particles include method such as ball-milled, magnetic stirring, high speed homogenizer, high pressure homogenizer, and ultrasound sonication. Conductive oxides may be used in combination or in the alternative including indium tin oxide, antimony oxide, antimony tin oxides, indium oxide, zinc oxide, zinc aluminum oxide, etc.

The cured nano-composites can directly be plated in commercially available plating solutions such as (copper) Cu, (nickel) Ni, (cobalt) Co, (silver) Ag, (gold) Au, (tin) Sn, (palladium) Pd etc. without any post-treatment after curing. It not only saves time and cost, but also achieve consistent and reliable plating. Traditional methods may require activation process such UV or thermal activation, or both. In an embodiment, the plated layer of copper can be further plated by Ni, Ag, Sn, Pd or, preferably, Au for lower contact resistance and better protection from oxidation.

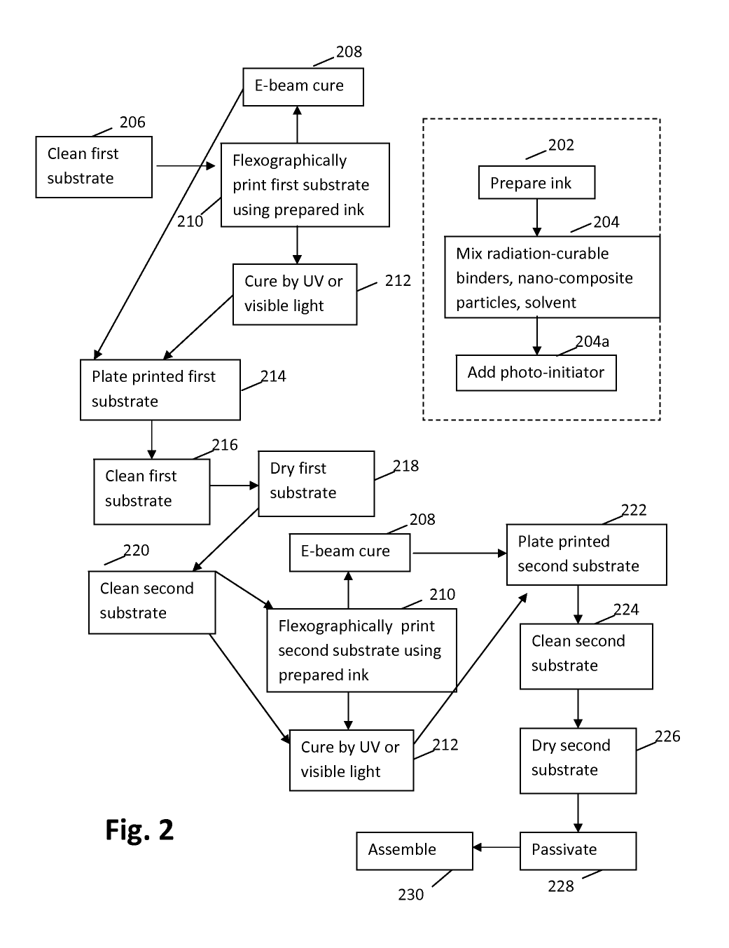

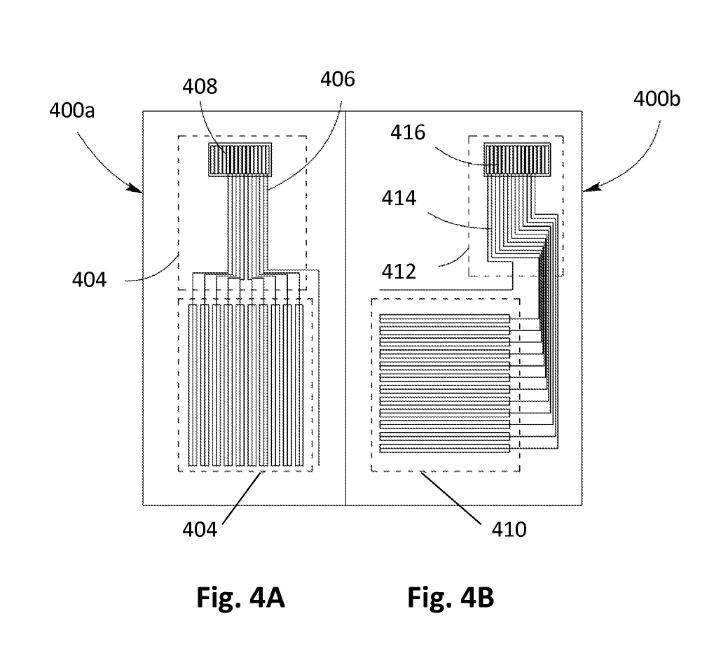

FIG. 2 is an embodiment of a method of manufacturing a touch sensor. Ink is prepared at ink preparation station 202 by mixing a plurality of radiation curable binders and a plurality of nano-composite particles and at least one solvent 204 and, in some embodiments, adding at least one photo-initiator 204a. The nano-composite particles are discussed above and are generally metallic particles with a coating which may also be referred to as seeds because one purpose of the nano-composite particles is to act as seeds for the plating process. The ink may be prepared at ink preparation station 202 prior to the substrate or concurrent with first cleaning at cleaning station 206. Cleaning station 206 is used to clean a first substrate which is then printed using flexographic printing at printing station 210 using the ink prepared at ink preparation station 202. It is appreciated that printing station 210 may comprise one or more print rollers and that in some embodiments these print rollers may use more than one type of ink. In that example, more than one ink preparation at ink preparation station may occur. After printing at print station 210, the first substrate is cured by ultraviolet light or visible light. As noted above, if there is no photo-initiator in the ink, it may be cured using an e-beam. The printing station 210 prints a pattern on the substrate comprising a plurality of lines as discussed below at least in FIGS. 4A-4C, 5A and 5B, and 6. The pattern printed at station 210 is plated at plating station 214 by, for example, an electroless plating process. The geometry of the printed pattern may be related and correlated to the desired geometry of the plated pattern. For example, if a line less than 10 microns wide is needed in the conductive pattern formed by plating, the ink thickness is from about 50 nm to about 1000 nm. In other embodiments, the ink thickness may be from 10 nm to 1.5 microns thick. In another example, the plated conductive lines may also be between about 3 microns to about 500 microns wide. After plating station 214, the first substrate is cleaned at second cleaning station 216 and dried at first drying station 218.

In order to make a capacitive or resistive touch sensor, a grid is formed by two patterns of lines. In an embodiment, a second substrate is cleaned at third cleaning station 220. The term “second substrate” may refer to three possible configurations. In the first configuration, the second substrate is the same side of the first substrate manufactured at blocks 206-218 wherein the second pattern is printed adjacent to the first pattern. In the second configuration, the second substrate may be the second side of the first printed pattern opposite the first printed pattern. In the third configuration, the second substrate may be a new substrate not previously printed in this process. Preferably, the second pattern is printed in any of the three configurations prior to plating the first pattern and the first and the second printed patterns are plated simultaneously. In some embodiments of the first or the third configurations, one or both substrate has a plurality of spacers (not pictured) printed on one or both printed patterns. Regardless of the configuration, the second pattern is printed at printing station 210 which, as discussed above, may comprise the same roller or rollers and ink as used to print the first substrate or may comprise a different roller or roller and a different ink than used to print the first pattern on the first substrate at printing station 210. The printed second pattern is cured either at curing station 208 using an e-beam cure if the ink used to print the second pattern does not contain photo-initiators or at curing station 212 using UV light or visible light. After curing either at curing station 208 or curing station 212, the second printed pattern is plated at plating station 222 with a conductive material and cleaned at fourth cleaning station 224, dried at drying station 226, and passivated at passivation station 228.

Depending upon the configuration, the first and the second plated substrates may be assembled at assembly station 230. In the first configuration, the first and the second substrate are printed and subsequently plated adjacent to each other. In this example, the substrate may be cut, trimmed, and assembled with the patterns oriented orthogonally, or the substrate may be folded to create the alignment. An adhesive may be used at the assembly station 230. In the second configuration, both patterns are printed on opposite sides of the same substrate so the assembly station 230 may not be needed or may comprise trimming or other finishing steps. In the third configuration, the first and the second pattern are printed on separate substrates and the substrates may be trimmed and assembled using an adhesive at assembly station 230.

In one example, (not pictured) the ink is prepared by mixing binders, specifically by mixing 176 g of epoxy acrylate with 112 g of pentaerythritol tetraacrylate and 124 g of polyethylene glycol diacrylate. Then, 17 gram of ˜25 nm carbon nanoparticles and 103 grams of 25 nm carbon-coated Cu or Ag particles may be added into the solution. A sonicator may be used to help dispersion until a second homogeneous solution is obtained. The nano-composite obtained shows thixotropic property the resulting nano-composite may exhibit thixotropic properties which may help in printing small features without a polymer bleeding or a line widening phenomenon. In some embodiments, photo-initiators such as 24.7 grams of 1-hydroxycyclohexyl phenylketone and 12.4 grams of 2-benzyl-2-(dimethylamino)-4′-morpholinobutyrophenone, and 12.4 gram triarylsulfonium hexafluoroantimonate salts, mixed, 50% in propylene carbonate may be added into the mixture and stirred until completely dissolved. It is understood that the binders, photoinitiators, and nano-composite particles may be added into the solution in various orders and combinations so long as the end mixture is homogenous and the nano-composite particles are dissolved.

In another example, an ink is mixed as described above except 73 grams of 25 nm carbon-coated Ag or Ni particles were added to the solution. The amount of nano-composite particles used in an ink solution may impact the visibility of the plated lines because, in some applications, a darker pattern may be more desired and so the optical properties of the plated pattern are tuned using the composition of the ink and, specifically, the amount and type of nano-composite particles used to manufacture the ink. The nano-composites may present other benefits to very fine 1 micron-20 micron-wide lines such as good adhesion to the base material of the substrate so the substrate does not require pre-treatment with a primer layer or the reduction process of metal ions that occurs with inks that comprise plating catalysts as opposed to the nano-composite particles. Plating rates for the first and the second pattern may vary from 18 nm/min-60 nm/min at a temperature from 35° C.-45° C. The plating can be achieved using the nano-composite ink at operating temperatures from 20° C.-70° C. In some embodiments, the plating may be carried out at room temperature at a slower rate and still exhibits sufficient adhesion even after a longer process than would be performed at elevated processing temperatures.

In another example, up to 300 gram of solvent such as 1-methoxy-2-propanol can be added to the above composition. In an embodiment, a solvent containing ink can be printed without a subsequent thermal baking step and can be cured by UV exposure. In this embodiment, benefits of introducing solvents into the composition may include: a) the ink is less viscous and is easier to transfer and replenish; b) smoother printed line surfaces; c) smaller printed line widths; d) printed line edge is smooth and less distorted; e) more consistent, easily controlled line quality; f) reduced cost of printed ink.

The solvents that are qualified to be used in the compositions disclosed herein may comprise the following properties: a) compatible with the binder composition, namely, they can form a homogeneous solution without any noticeable phase segregation; b) compatible with nano-particles without causing aggregation; c) maintain the suspension of nano-particle within the binder composition during ink storage and during printing operations; d) cannot interfere with the radiation-induced curing process; e) cannot interfere with the following plating process or the bleaching of the solvent does not adversely affect the plating process; f) does not swell, dissolve, attack, or distort the design features on the flexo-plate during the lifetime of the flexo-plate; g) does not cause bleeding or widening of printed fine features; h) does not change the ink rheology such as the thixotropic properties.

Examples of qualified solvents include 2-ethoxyethanol, 2-(2-methoxy ethoxy)ethanol, 2-(2-ethoxyethoxy)ethanol, 1-methoxy-2-propanol, heptanone-4, heptanone-3, heptanone-2, cyclopentanone, cyclohexanone, diethyl carbonate, 2-ethoxyethyl acetate, N-butyl butyrate, methyl lactate, etc. A mixture of solvents is also possible and included. The amount of solvents varies with specific type of solvents used, designed features, their dimension, and anilox. Better compatibility between the ink system allows higher solvent content. In an embodiment, the solvent comprises 5-50 wt % of the ink.

Master Plate Formation

Flexography is a form of a rotary web letterpress where relief plates are mounted on to a printing cylinder, for example, with double-sided adhesive. These relief plates, which may also be referred to as a master plate or a flexoplate, may be used in conjunction with inks comprising fast drying, low viscosity solvents, and ink fed from anilox rollers or other two-roller inking systems. The anilox roll may be a cylinder used to provide a measured amount of ink to a printing plate. The ink may be, for example, water-based or ultraviolet (UV)-curable inks. In one example, a first roller transfers ink from an ink pan or a metering system to a meter roller or anilox roll. The ink is metered to a uniform thickness when it is transferred from the anilox roller to a plate cylinder. When the substrate moves through the roll-to-roll handling system from the plate cylinder to the impression cylinder, the impression cylinder applies pressure to the plate cylinder which transfers the image on to the relief plate to the substrate. In some embodiments, there may be a fountain roller instead of the plate cylinder and a doctor blade may be used to improve the distribution of ink across the roller.

Flexographic plates may be made from, for example, plastic, rubber, or a photopolymer which may also be referred to as a UV-sensitive polymer. The plates may be made by laser engraving, photomechanical, or photochemical methods. The plates may be purchased or made in accordance with any known method. The preferred flexographic process may be set up as a stack type where one or more stacks of printing stations are arranged vertically on each side of the press frame and each stack has its own plate cylinder which prints using one type of ink and the setup may allow for printing on one or both sides of a substrate. In another embodiment, a central impression cylinder may be used which uses a single impression cylinder mounted in the press frame. As the substrate enters the press, it is in contact with the impression cylinder and the appropriate pattern is printed. Alternatively, an inline flexographic printing process may be utilized in which the printing stations are arranged in a horizontal line and are driven by a common line shaft. In this example, the printing stations may be coupled to curing stations, cutters, folders, or other post-printing processing equipment. Other configurations of the flexo-graphic process may be utilized as well.

In an embodiment, flexo plate sleeves may be used, for example, in an in-the-round (ITR) imaging process. In an ITR process, the photopolymer plate material is processed on a sleeve that will be loaded on to the press, in contrast with the method discussed above where a flat plate may be mounted to a printing cylinder, which may also be referred to as a conventional plate cylinder. The flexo-sleeve may be a continuous sleeve of a photopolymer with a laser ablation mask coating disposed on a surface. In another example, individual pieces of photopolymer may be mounted on a base sleeve with tape and then imaged and processed in the same manner as the sleeve with the laser ablation mask discussed above. Flexo-sleeves may be used in several ways, for example, as carrier rolls for imaged, flat, plates mounted on the surface of the carrier rolls, or as sleeve surfaces that have been directly engraved (in-the-round) with an image. In the example where a sleeve acts solely as a carrier role, printing plates with engraved images may be mounted to the sleeves, which are then installed into the print stations on cylinders. These pre-mounted plates may reduce changeover time since the sleeves can be stored with the plates already mounted to the sleeves. Sleeves are made from various materials, including thermoplastic composites, thermoset composites, and nickel, and may or may not be reinforced with fiber to resist cracking and splitting. Long-run, reusable sleeves that incorporate a foam or cushion base are used for very high-quality printing. In some embodiments, disposable “thin” sleeves, without foam or cushioning, may be used.

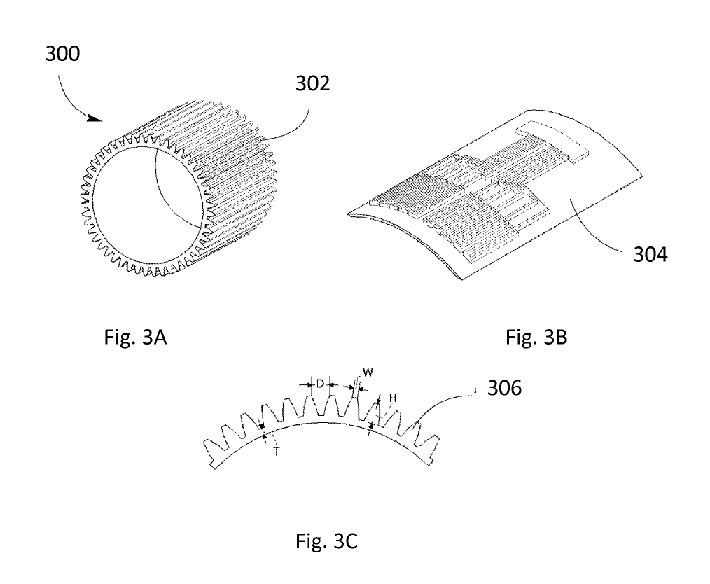

FIGS. 3A-3C are illustrations of flexo-master embodiments. As noted above, the terms “master plate” and “flexo-master” may be used interchangeably. FIG. 3A is an isometric view 300 of a straight line flexo-master 302 which is cylindrical. FIG. 3B is an isometric view of an embodiment of a circuit-patterned flexo-master 304. FIG. 3C is a cross sectional view at block 306 of a portion of straight lines flexo-master 302 as shown in FIG. 3A. FIG. 3C also depicts “W” which is the width of the flexo-master protrusions, “D,” is the distance between the center points of the plurality of protrusions 306 and “H” is the height of the protrusions 306. In an embodiment (not pictured), one or all of D, W, and H may be the same across the flexo-master. In another embodiment (not pictured), one or all of D, W, and H may vary across the flexo-master. In an embodiment (not pictured) width W of flexo-master protrusions is between 3 and 5 microns, distance D between adjacent protrusions is between 0.02 mm and 5 mm, height H of the protrusions may vary from 0.020 microns to 300 microns and thickness T of the protrusions is between 1.67 and 1.85 mm. In an embodiment, printing may be done on one side of a substrate, for example, using one roll comprising both patterns, or by two rolls each comprising one pattern, and that substrate may be subsequently cut and assembled. In an alternate embodiment, both sides of a substrate may be printed, for example, using two different print stations and two different flexo-masters. Flexo-masters may be used, for example, because printing cylinders may be expensive and hard to change out, which would make the cylinders efficient for high-volume printing but may not make that system desirable for small batches or unique configurations. Changeovers may be costly due to the time involved. In contrast, flexographic printing may mean that ultraviolet exposure can be used on the photo plates to make new plates that may take as little as an hour to manufacture. In an embodiment, using the appropriate ink with these flexo-masters may allow the ink to be loaded from, for example, a reservoir or a pan in a more controlled fashion wherein the pressure and surface energy during ink transfer may be able to be controlled. The ink used for the printing process may need to have properties such as adhesion, viscosity, and additives so that the ink stays in place when printed and does not run, smudge, or otherwise deform from the printed pattern, and so that the features formed by the ink join to form the desired features. Each pattern may, for example, be made using a recipe wherein the recipe comprises at least one flexo-master and at least one type of ink. Different resolution lines, different size lines, and different geometries, for example may require different recipes.

FIG. 4A is an illustration of an embodiment of a top view of one side of a flexible film that has a pattern 400a that is to be printed on a substrate. A first pattern 400a may be printed on one side of a first flexible polarizer film, including a first plurality of lines 402 that may constitute the Y oriented segment of an X-Y grid, and tail 404 comprising electrical leads 406 and electrical connectors 408. FIG. 4B is an illustration of an embodiment of a second pattern 400b which may be printed on one side of a second flexible polarizer film, comprising a second plurality of lines 410 that may constitute the X oriented segment of an X-Y grid (not pictured) and tail 412 comprising electrical leads 414 and electrical connectors 416. In an embodiment, both the first and the second patterns combined will form an X-Y grid that will match in size and shape the black matrix embedded in an RGB filter (not pictured).

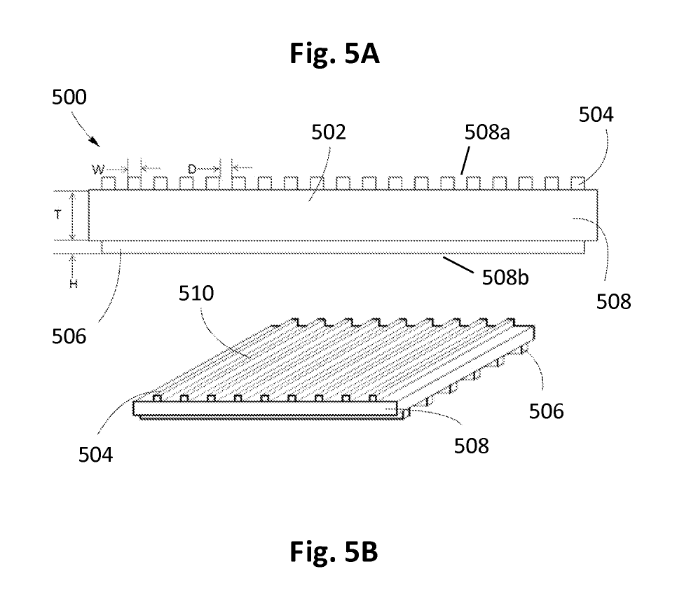

FIGS. 5A and 5B are embodiments of circuit structures. FIG. 5A depicts circuit structure 500 which represents a cross-sectional view of a capacitive touch sensor. FIG. 5B is an Isometric view 510 of a capacitive touch sensor. The top 508a and bottom 508b sides of film 508 are coated with thin, opaque, flexible patterns of conductive material. In both FIGS. 5A and 5B top electrodes 504 and bottom electrodes 506 are shown printed on the top 508a and bottom 508b of flexible polarizer film 508. Materials used for the electrodes may be, for example, copper (Cu), silver (Ag), gold (Au), nickel (Ni), tin (Sn), and Palladium (Pd). Depending on the resistivity of the materials used for the circuit, it may have different response times and power requirements. In some embodiments, the circuit lines may have a resistivity between 0.005 micro Ohms and 1000 Ohm per square and response times may be in a range between nanoseconds and picoseconds. Preferably, the resistivity is between 2-10 Ohms per square. In this example “per square” refers to the square created when two patterns are assembled orthogonally to each other to form what may be referred to as a grid or an x-y grid. In general, with the above electrode metal configuration, circuits consuming 75% less power than those using ITO (Indium Tin Oxide) may be achieved.

In the embodiments pictured in FIGS. 5A and 5B, the cross sectional geometry of the plurality of electrode lines is a square. However, the cross sectional geometry of each of the plurality of lines may be any suitable shape such as a rectangle, a square, a trapezoid, a triangle, or a half-circle. The width W of the printed electrodes may vary from 5 to 35 microns and has a tolerance of +/−10%. The spacing D between the lines may vary from about 0.01 mm to 5 mm. For optimal optical performance the conductive patterns should match the size and shape of the display's black matrix. As such, spacing D and width W may be functions of the size of the black matrix of the display. Height H may range from about 150 nanometers to about 6 microns. Film 508 exhibits thickness T between 1 micron and 1 millimeter and a preferred surface energy from 20 dynes per centimeter (D/cm) to 90 dynes/cm. While a first and a second plurality of lines are disclosed above, the above dimensional information may apply to one or both of the pluralities of lines disclosed above.

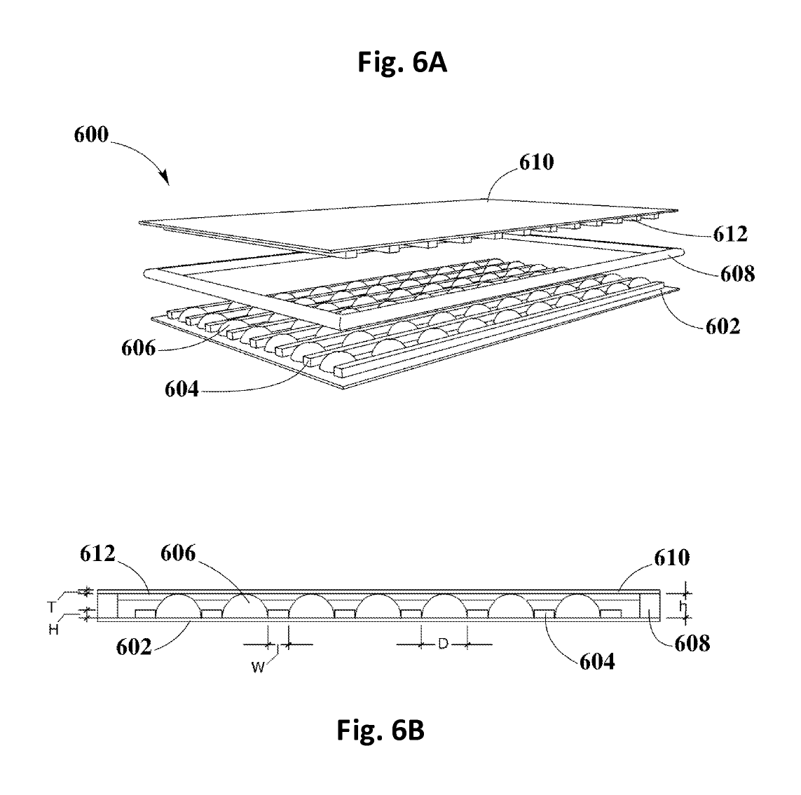

FIGS. 6A-6B are illustrations of an isometric view and a cross-section of a resistive touch sensor structure. FIG. 6A shows an isometric view 600 of a resistive touch sensor. FIG. 6B illustrates a cross-sectional view of a resistive touch sensor comprising a first plurality of conductive lines 604 and a plurality of spacer dots 606 disposed on a first substrate, polarizer film 602, a second plurality of conductive lines 612 is disposed on second substrate 610 and adhesive promoting agent 608, bonding polarizer film 602 and second substrate 610, where second substrate 610 is an optically isotropic transparent film. Materials used to form the conductive lines may comprise copper (Cu), silver (Ag), gold (Au), nickel (Ni), tin (Sn) and Palladium (Pd). Depending on the resistivity of the materials used for the circuit, the circuit may have different response times and power requirements.

In some embodiments, the circuit lines may have a resistivity between 0.005 micro Ohms per square and 1000 Ohm per square and response times in a range between nanoseconds and picoseconds. In general, with the above metal configuration, circuits consuming 75% less power (or more in some embodiments) than those using ITO (Indium Tin Oxide) may be achieved. In one particular embodiment the width W of the printed electrodes varies from 5 to 10 microns with a tolerance of +/−10%. The spacing D between the lines may vary from about 0.1 mm to 5 mm. For optimal optical performance the conductive patterns should approximately match the size and shape of the display's black matrix. Hence, spacing D and width W are functions of the size of the black matrix of the display. Height H may range from about 6 nanometers to about 150 microns. Height h of adhesive promoting agent 608 and the plurality of spacer dots 606 may be 500 nanometers or more, depending on the height H of the conductive lines. In an embodiment, the height of the adhesive promoting agent 608 and the height of the plurality of spacer dots 606 are not the same. Polarizer film 602 and second substrate 610 may have a thickness T between 1 micron and 1 millimeter and a surface energy from 20 dynes per centimeter (D/cm) to 90 D/cm.

Printing of High Resolution Conductive Lines

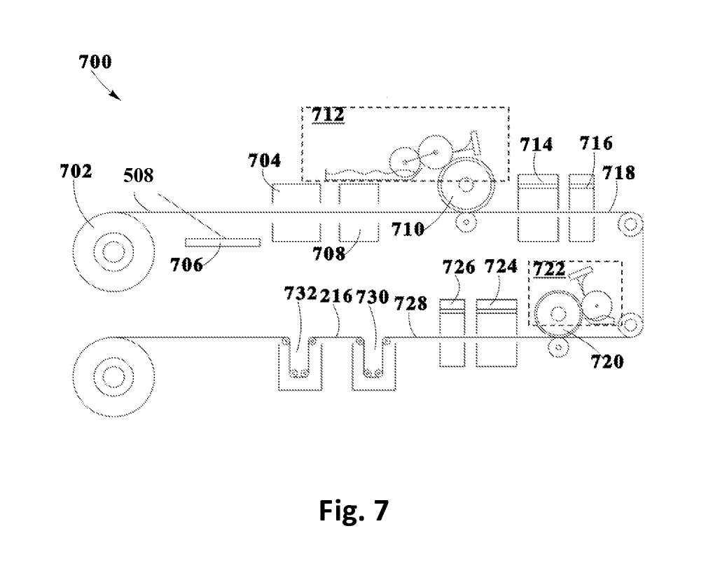

FIG. 7 is an embodiment of a manufacturing method to fabricate a capacitive touch sensor. Manufacturing method 700 is a method to fabricate a capacitive touch sensor. In FIG. 7, an elongated, flexible, thin film 508 is placed on unwind roll 702. The thickness of polarizer film 508 may be chosen so that it is thin enough to avoid excessive stress during flexing of the touch sensor and, in some embodiments, to improve optical transmissivity, and thin enough as to preserve the continuity of the layer and/or its material properties during the manufacturing process. Preferably, the thickness of the film 508 may be between 1 micron and 1 millimeter.

Thin film 508 is transferred, preferably via a roll to roll handling method, from unwind roll 702 to first cleaning station 704. In some embodiments, the film 508 may be a polarizer film. As the roll to roll process involves a flexible material, the alignment of features may be somewhat challenging. Given that printing high resolution lines may be desirable, precision in maintaining the proper alignment may be accounted for in the setup and manufacturing process. In one embodiment positioning cable 706 is used to maintain proper alignment of the features, in other embodiments any known means may be used for this purpose. If the alignment is off, the printing process disclosed below may not proceed correctly, which may result in both cost and safety implications. In some embodiments first cleaning station 704 comprises a high electric field ozone generator. The ozone generated is used to remove impurities such as oil or grease from film 508.

Film 508 then passes through a second cleaning at second cleaning station 708. In this particular embodiment, second cleaning station 708 includes a web cleaner. A web cleaner may be any device used in web manufacturing to remove particles from a web or substrate. After cleaning stations 704 and 708, film 508 passes through a first printing process 712 where a microscopic pattern is printed on one of the sides of film 508. The microscopic pattern is imprinted by master plate 710 using radiation curable ink (not pictured) that may have a viscosity between 200 and 2000 cps. In some embodiments, the ink has a viscosity of 500-10,000 cps at 25° C.

The ink may be a combination of monomers, oligomers, or polymers, solvents, metal elements, metal element complexes, or organometallics in liquid state that is discretely applied over a substrate surface. Further, the microscopic pattern comprises lines having a width between 2 and 20 microns and may be similar to the first pattern shown in FIG. 5A. The amount of ink transferred from master plate 710 to film 508 is regulated by high precision metering system 712 and depends on the speed of the process, ink composition, as well as the pattern shape, dimensions, and cross-sectional geometry of the plurality of lines that comprise the pattern. The speed of the machine may vary from 20 feet per minute (fpm) to 1000 fpm, while 50 fpm to 200 fpm may be suitable for some applications.

The first printing process 712, 712, may be followed by a curing process at curing station 714 to form patterned lines from the printed ink pattern. The curing process may refer to the process of drying, solidifying or fixing any coating or ink imprint, previously applied, on a substrate. The curing may comprise ultraviolet light curing station 714 with a target intensity from about 0.5 mW/cm2 to about 50 mW/cm2 and wavelength from about 200 nm to about 480 nm. In some embodiments, an additional curing step may be utilized at second curing station 716, this curing at second curing station 716 may be a full cure or a partial cure depending upon the embodiment.

The unpatterned bottom side of film 508 is then printed so as to form a microscopic pattern representing the electrodes of the touch sensor on the opposite side of the film 508 from the electrodes printed as described above. A microscopic pattern is printed on the bottom side of film 508. The microscopic pattern is imprinted by second master plate 720 using UV curable ink. A pattern similar to the second pattern shown in FIG. 5 may be used. The amount of ink transferred from second master plate 720 to the bottom side of film 508 is regulated by high precision metering station 722. This second printing process may be followed by a curing step at third curing station 724. The curing may comprise ultraviolet light third curing station 724 with a target intensity from about 0.5 mW/cm2 to about 50 mW/cm2 and wavelength from about 200 nm to about 480 nm. In an embodiment, similar to second curing station 716, fourth curing station 726 may be utilized.

Electro-less Plating

With printed microscopic patterns on both sides of the film 508, first patterned lines 718 and bottom patterned lines 728, film 508 may be exposed to electroless plating station 730. It is appreciated that the top 718 and bottom 728 patterned lines which have been printed and cured are indicated in FIG. 7 but not pictured in detail. The term “electroless plating” may describe a catalyst-activated chemical technique used to deposit a layer of conductive material on to a given surface. The nano-composites, the coated nano-particles, or “seeds” as they may be referred to, may be used instead of or in addition to traditional plating catalysts and solvents in the ink when room-temperature plating is desired. The nano-composites act as seeds for the plating process. In addition, it is appreciated that a secondary curing may not be utilized even if the ink contains a solvent or other liquid. In an embodiment, the deposition of conductive material is performed from 1 nm/min-100 nm/min, preferably from 30 nm/min-70 nm/min.

At plating station 730, a layer of conductive material is deposited on the microscopic patterns 718 and 728. This may be accomplished by submerging first patterned lines 718 and bottom patterned lines 728 of film 508 into an electroless plating station 730 using a tank that contains copper or other conductive material in a liquid state at a temperature range between 20° C. and 90° C., with 80° C. being applied in some embodiments. The deposition rate may be 10 nanometers per minute and within a thickness of about 0.001 microns to about 100 microns, depending on the speed of the web and according to the application. This electroless plating process does not require the application of an electrical current and it only plates the patterned areas containing the ink that were previously activated by the exposure to UV radiation during the curing process. In other embodiments, nickel is used as the plating metal. The copper plating bath may include reducing agents, such as formaldehyde, borohydride, or hypophosphite, which cause the plating to occur. The plating thickness tends to be uniform compared to electroplating due to the absence of electric fields. Electroless plating may be well suited for complex geometries that may comprise fine features. After the plating station 730, the capacitive touch sensor is formed by the printed conductive lines 718 and 728 on both sides of film 508. Usually, a second metal layer such as nickel is introduced on top of copper.

After electroless plating station 730, a capacitive touch sensor may be cleaned at washing station 732 by being submerged into a cleaning tank that contains water at room temperature and dried through the application of air at room temperature. In another embodiment, a passivation step in a pattern spray may be added after the drying step to prevent any dangerous or undesired chemical reaction between the conductive materials and water. In this example, film 508 is printed on both sides. In a second example, a first film may be printed on one side and a second film may be printed on one side and the films processed as indicated below and then assembled. In a third example, a first film may have two patterns printed on one side of the film, and the film is then processed as indicated below, then cut and assembled. In the second and third examples, the assembly process comprises assembling the two patterns to where the plurality of lines of the first pattern is assembled orthogonally to the plurality of lines of the second pattern to form an x-y grid. This assembly process may comprise cutting or tearing the patterns apart, the substrate may in some embodiments have a mark indicating where to cut, or have perforations making it easier to tear. In an alternate embodiment, the patterns can be folded on each other, wherein they do not need to be separated prior to folding or wherein the folding separates the substrate in between the patterns due, for example, to a marking, indentation, or perforations in the substrate. In some embodiments, the marking or perforations may be added prior to processing, and other embodiments the marking or perforations may be added during processing.

Precision Metering System

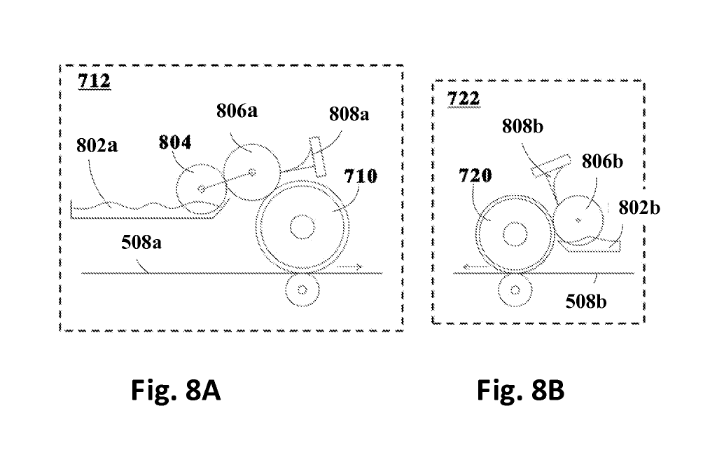

FIGS. 8A and 8B are embodiments of high precisions metering systems. The printing process is where the ink pattern that will ultimately be plated with conductive material is formed. Therefore, the integrity of the printed pattern, the line shape, thickness, uniformity, and pattern formation may impact the integrity of the plated pattern. FIG. 8A is an embodiment of high precision metering stations 712 and FIG. 8B is an embodiment of high precision metering station 722. Both stations 712 and 722 control the amount of ink that is transferred to film 508 by first master plate 710 in FIG. 8A and second master plate 720 in FIG. 8B as described in both printing steps of manufacturing method 700 in FIG. 7. In a preferred embodiment, the station in FIG. 8A is used to print a first side of a substrate and the station in FIG. 8B is used to print the other (second) side of the substrate. FIG. 8A shows ink pans 802a, transfer roll 804, anilox rollers 806a, doctor blades 808a and the master plate 710. An anilox roll may be a cylinder used to provide a measured amount of ink to a printing plate, more than one roll may be used in a single process and the roll or rolls may be used in conjunction with an ink pan or with a metered ink system. In one embodiment, a portion of the ink contained in ink pan 802a is transferred to anilox roller 806a, which may be constructed of a steel or aluminum core coated by an industrial ceramic whose surface contains millions of very fine dimples, known as cells. Depending on the design of the printing process, anilox roller 806a may be either semi-submersed in ink pans 802a or come into contact with a metering roll (not pictured). Doctor blades 808a are used to scrape excess ink from the surface leaving just the measured amount of ink in the cells. The rollers then rotate to contact with the flexographic master plate 710 which receives the ink from the cells for transfer to film 508a. The rotational speed of the printing plates should match the speed of the web, which may vary between 20 fpm and 750 fpm. In FIG. 8B, ink is transferred from ink pan 802b to anilox roller 806b. Doctor blades 808b may be used to scrap excess ink from the surface as in FIG. 8A, and the rollers rotate to contact with master plate 720 which transfers the ink to substrate 508b. In an alternate embodiment, substrate 508a is different than substrate 508b.

Final Product Film

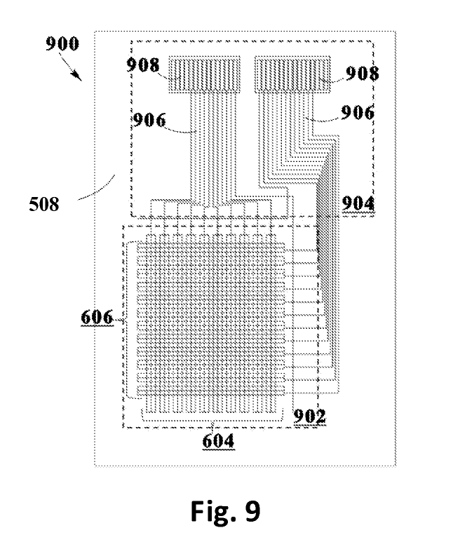

FIG. 9 shows a top view 900 of the capacitive touch sensor. Shown in this figure are conductive grid lines 902 which are the electrodes and tail 904 comprising electrical leads 906 and electrical connectors 908. The electrodes 902 and tail 904 are formed by plating the patterns printed by the flexographic printing process disclosed above. These electrodes form an x-y grid that enables the recognition of the point where the user has interacted with the sensor. This grid may have 16×9 conductive lines or more and a size range of, for example, from 2.5 mm by 2.5 mm to 2.1 m by 2.1 m. Top electrodes 604 which are the conductive lines corresponding to the Y axis and were printed on the first side of the film 508 and bottom electrodes 606 which are the conductive lines corresponding to the X axis were printed on the second side of the film 508.

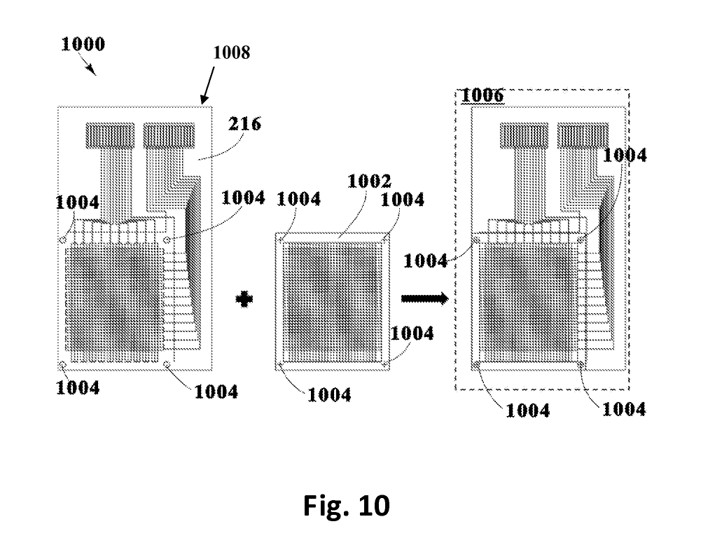

FIG. 10 is an illustration of an alignment method. Alignment method 1000 is used to match the position of the touch sensor 1008 and black matrix 1002 of a given display. In this particular embodiment touch sensor 1008 and black matrix 1002 are aligned using registration marks 1004. Preferably, touch sensor 1008 and black matrix 1002 have substantially the same size and shape and be properly aligned as in aligned structure 1006. Other known methods of alignment may also be employed. In an embodiment (not pictured) where a resistive touch sensor is assembled, the plurality of spacer dots may also be used in the alignment process.

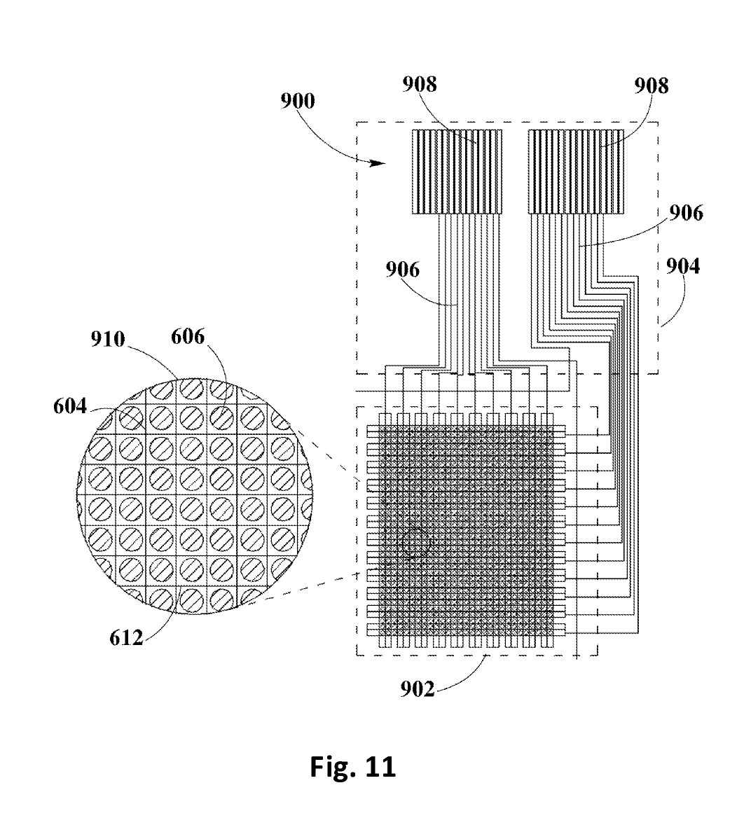

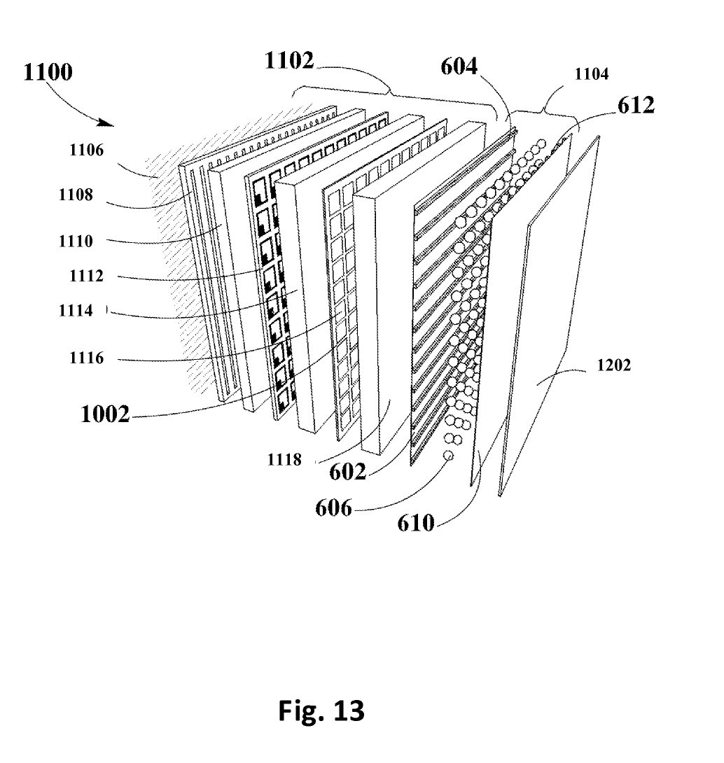

FIG. 11 depicts an enlarged view 910 in which a plurality of spacer dots 606 and the X-Y grid, formed by first conductive lines 604 and second conductive lines 612 are shown. FIG. 11 is an embodiment of a top view 900 of a resistive touch sensor 1104, as depicted in FIG. 13, built on film 602 in accordance with various embodiments. Shown in this figure are conductive grid lines 902 and tail 904 comprising electrical leads 906 and electrical connectors 908. These conductive lines form an x-y grid that enables the recognition of the point where the user has interacted with the sensor. This grid may have 16×9 conductive lines or more and a size range from 2.5 mm by 2.5 mm to 2.1 m by 2.1 m. Conductive lines corresponding to the Y axis and spacer dots (not pictured) were printed on film 602 and conductive lines corresponding to the X axis were printed on a second optically isotropic transparent substrate. As explained above, the spacer dots may be printed on either of the two films.

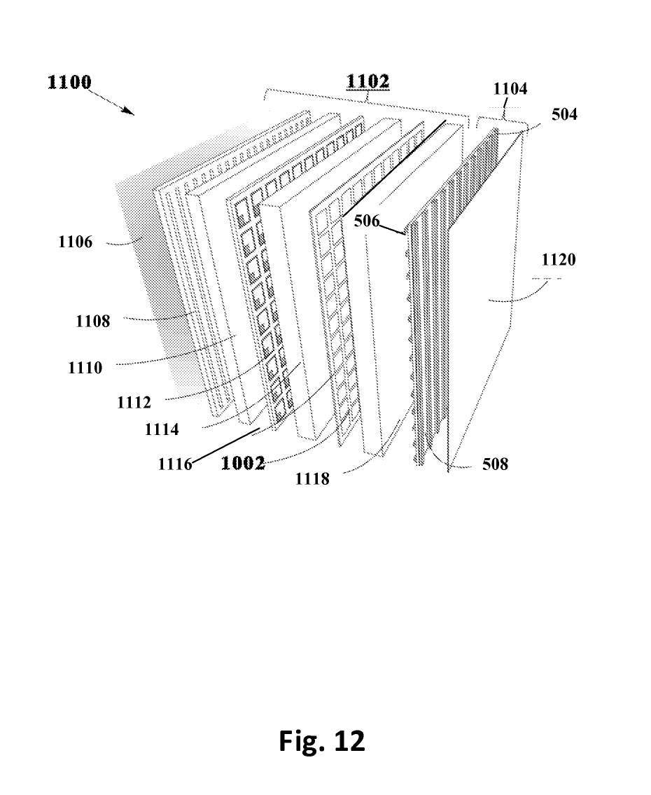

FIG. 12 shows an exploded isometric view of a display having a capacitive touch screen structure. The isometric view 1100 may be, for example, of touch screen structure 100 shown in FIG. 1, and may comprise LCD 1102, touch sensor 1104, and cover glass 1120. LCD 1102 comprises a light source 1106, such as a backlight, wherein the backlight 1106 comprises at least one of a light source, enhancement films, and diffuser plates. The LCD 1102 further comprises polarizer 1108 is disposed on backlight 1106, and first glass substrate 1110 is disposed on the first polarizer 1108. A TFT layer 1110 is disposed on the glass substrate 1110 and liquid crystal cells 1114 are disposed on the TFT layer 1112. A black matrix 1002 is embedded in RGB filter 1116 and is disposed between the liquid crystal cells 1114 and a second glass substrate 1118. Touch sensor 1104 may be disposed on second glass 1118. Touch sensor 1104 may comprise top electrodes 504 and bottom electrodes 506, wherein the top electrodes 504 and the bottom electrodes 506 were printed, in an embodiment, on two sides of the same polarizer film. In another embodiment, top electrodes 504 were printed on a first side of a first film 508 and bottom electrodes 506 were printed on a first side of a second film and subsequently assembled. Cover glass 1120 may be placed on top of touch sensor 1104. In some embodiments, a hard coating (not pictured) may be applied on the outer surface of touch sensor 1104.

FIG. 13 shows isometric exploded view 1100 of a resistive touch screen structure. In this figure we can see LCD 1102, comprising light source 1106, first polarizer 1108, first glass substrate 1110, TFT 1112 layer, liquid crystal cells 1114, and black matrix 1002 embedded on RGB filter 1116 and second glass substrate 1118. A first polarizer 204 is disposed on light source 1106. The TFT layer 1112 is disposed on first glass substrate 1110 and liquid crystal cells 1114 are disposed on top of the TFT layer 1112. The RGB filter 1116 is disposed on liquid crystal cells 1114 and has embedded black matrix 1002. The second glass substrate 1118 is disposed on the RGB filter 1116. The touch screen structure also comprises touch sensor 1104. Touch screen sensor 1104 comprises a first plurality of conductive lines 604 printed on polarizer film 602, spacer dots 606, and a second substrate 610. The second substrate 610 comprises a second plurality of conductive lines 612. In some embodiments, on top of touch sensor 1104, a cover film 1202 may be placed. Alternatively, a hard coating (not pictured) may be applied on the outer surface of touch sensor 1104 to replace cover film 1202. While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

1-3. (canceled)

4. The method of claim 8, wherein the plurality of coated electrically conductive nanoparticles include nano-metals, nano-oxides, nano-carbon-based nano-tubes nano-graphene, or bucky-balls.

5. The method of claim 4, wherein the plurality of coated electrically conductive nanoparticles further include copper (Cu), nickel (Ni), cobalt (Co), silver (Ag), gold (Au), iron (Fe), tin (Sn), Palladium, (Pd), or zinc (Zn).

6. The method of claim 4, wherein the plurality of coated electrically conductive nanoparticles further include a nano-oxide, wherein the nano-oxide includes indium tin oxide, antimony oxide, antimony tin oxide, indium oxide, zinc oxide, zinc aluminum oxide, or combinations thereof.

7. (canceled)

8. A method of manufacturing a touch screen sensor comprising:
printing, using a first master plate and an ink, a first pattern on a first side of a first substrate, wherein the first pattern includes first plurality of lines and a first tail, and wherein the ink includes plurality of binders, a solvent, and a plurality of carbon coated electrically conductive nanoparticles;
curing the substrate;
printing using a second master plate and the ink, a second pattern on one of a second substrate, the first side of the first substrate, or a second side of the first substrate, wherein the second pattern comprises a second plurality of lines and a second tail;
curing the substrate;
plating the first pattern and the second pattern;
forming the touch screen sensor including the plated first pattern and the plated second pattern;
wherein curing the substrate uses at least one of an ionizing radiation source, a visible light source, or an ultraviolet light source.

9-10. (canceled)

11. The method of claim 8, wherein preparing the ink further includes disposing the plurality of carbon coated electrically conductive nanoparticles into a first homogeneous viscous solution subsequent to disposing a photoinitiator into the first homogeneous viscous solution, and agitating the first homogeneous viscous solution until the photoinitiator is dissolved in the first homogeneous viscous solution to form a second homogenous viscous solution, and wherein curing the substrate uses a visible light source or an ultraviolet light source.

12. The method of claim 8, wherein the second pattern is printed on the first side of the first substrate adjacent to the first pattern.

13. The method of claim 8, further including printing a plurality of spacers on at least one of the first or second printed patterns, wherein the second pattern is printed on the second substrate or on the first side of the first substrate.

14. The method of claim 8, wherein plating the first and second patterns is performed by an electroless plating process that deposits a conductive material on to the first and second patterns, and wherein the conductive material includes one of copper (Cu), nickel (Ni), gold (Au), silver (Ag), tin (Sn), Palladium, (Pd), cobalt (Co), or combinations thereof.

15. The method of claim 8, wherein the method is performed by a roll-to-roll handling method at a speed of 20-1000 ft/min.

16. The method of claim 8, wherein the first and the second pattern are printed in series and the plating occurs after the first and second patterns are printed.

17. The method of claim 8, wherein the first and the second pattern are printed simultaneously and wherein plating the first and second patterns includes plating the patterns simultaneously after the first and second patterns are printed.

18. The method of claim 8, wherein printing and plating the first pattern occurs prior to printing and the plating the second pattern.

19. The method of claim 8, wherein each of the plurality of lines of the first and second patterns is from 1 micron-5 microns wide.

20. The method of claim 8, wherein each of the plurality of printed lines of the first and second patterns is between 10 nm-1.5 microns thick.

21. The method of claim 8, wherein each of the plurality of lines of the first and the second patterns has a resistivity from 0.005 Micro-ohms to 500 Ohms per cm.

22. (canceled)
